(19) United States
(12) Patent Application Publication
(10) Pub. No.: US 2023/0290324 A1
(43) Pub. Date: Sep. 14, 2023

(54) SOUND PROCESSING SYSTEM AND SOUND PROCESSING METHOD OF SOUND PROCESSING SYSTEM

(71) Applicant: YAMAHA CORPORATION, Hamamatsu-shi (JP)

(72) Inventors: Yoshimasa ISOZAKI, Hamamatsu-shi (JP); Ryotaro AOKI, Hamamatsu-shi (JP); Akihiko SUYAMA, Hamamatsu-shi (JP)

(21) Appl. No.: 18/179,680

(22) Filed: Mar. 7, 2023

(30) Foreign Application Priority Data
Mar. 8, 2022 (JP) 2022-035131

(51) Int. Cl. G10H 1/00; G10H 1/34

(52) U.S. Cl. CPC G10H 1/0008; G10H 1/34; G10H 1/0058; G10H 2210/091

(57) ABSTRACT

A sound processing system includes an electronic musical instrument and a sound processing apparatus communicable with the instrument. The instrument includes an audio signal generator that generates an audio signal according to a user performance on the electronic musical instrument, a first signal processor that performs first effect processing on the audio signal to generate a first processed audio signal, a first sound emitter that emits a first performance sound component based on at least one of the first processed audio signal or a second processed audio signal, and a first audio signal output that outputs the audio signal. The apparatus includes a first audio signal receiver that receives the audio signal output from the first audio signal output, in a state where the instrument is communicating with the apparatus, a second signal processor that performs second effect processing on the received audio signal, including removing a direct sound component from the received audio signal, to generate the second processed audio signal, and a second sound emitter that emits a second performance sound component based on the second processed audio signal. In the state where the instrument is communicating with the apparatus, the first signal processor changes the amount of the first effect processing to the generated audio signal in generating the first processed audio signal that is emitted by the first sound emitter, in a state where the audio signal is not output to the apparatus, or the first sound emitter emits the second performance sound component based on the second processed audio signal.

### CROSS REFERENCE TO RELATED APPLICATIONS

This Nonprovisional application claims priority under 35 U.S.C. § 119(a) on Patent Application No. 2022-035131 filed in Japan on Mar. 8, 2022, the entire contents of which are hereby incorporated by reference.

### BACKGROUND

### Technical Field

An embodiment of the present disclosure relates to a sound processing system and a sound processing method of the sound processing system.

### Background Information

Japanese Unexamined Patent Application Publication No. 2015-132695 discloses a system using a first musical instrument that produces a sound according to playing of a user and a second musical instrument that receives musical performance data from the first musical instrument and produces a sound.

Japanese Unexamined Patent Application Publication No. 2017-181686 discloses an electronic keyboard instrument that connects a surround speaker and outputs a reverb component.

The system disclosed in Japanese Unexamined Patent Application Publication No. 2015-132695 has no description of effect processing.

The system disclosed in Japanese Unexamined Patent Application Publication No. 2017-181686, since performing effect processing by an electronic musical instrument, only provides a sound by the effect processing of the electronic musical instrument.

### SUMMARY

One aspect of the present disclosure is directed to provide a sound processing system capable of providing a user with a rich effect sound that is unrealizable in effect processing of an electronic musical instrument.

A sound processing system according to an embodiment of the present disclosure includes an electronic musical instrument and a sound processing apparatus communicable with the electronic musical instrument.

The electronic musical instrument includes an audio signal generator that generates an audio signal according to a user performance on the electronic musical instrument, a first signal processor that performs first effect processing on the audio signal to generate a first processed audio signal, a first sound emitter that emits a first performance sound component based on at least one of the first processed audio signal or a second processed audio signal, and a first audio signal output that outputs the audio signal.

The sound processing apparatus includes a first audio signal receiver that receives the audio signal output from the first audio signal output, in a state where the electronic musical instrument is communicating with the sound processing apparatus, a second signal processor that performs second effect processing on the received audio signal, including removing a direct sound component from the received audio signal, to generate the second processed audio signal, a second sound emitter that emits a second performance sound component based on the second processed audio signal.

In the state where the electronic musical instrument is communicating with the sound processing apparatus, the first signal processor changes the amount of the first effect processing to the generated audio signal in generating the first processed audio signal that is emitted by the first sound emitter, in a state where the audio signal is not output to the sound processing apparatus, or the first sound emitter emits the second performance sound component based on the second processed audio signal.

Another aspect is a sound processing method for the sound processing system.

According to an embodiment of present disclosure, a rich effect sound that is unrealizable in effect processing of an electronic musical instrument is able to be provided to a user.

### BRIEF DESCRIPTION OF THE DRAWINGS

FIG. 1 is a diagram showing a configuration of a sound processing system 1.

FIG. 2 is a block diagram showing a configuration of an electronic piano 10.

FIG. 3 is a flow chart showing an operation of the electronic piano 10.

FIG. 4 is a flow chart showing the operation of the electronic piano 10 when a connection to a receiver 11 is detected.

FIG. 5 is a block diagram showing a configuration of the receiver 11.

FIG. 6 is a flow chart showing an operation of the receiver 11.

FIG. 7 is a flow chart showing the operation of the receiver 11.

FIG. 8 is a flow chart showing the operation of the electronic piano 10.

FIG. 9 is a block diagram showing a configuration of an electronic piano 10 according to a third modification.

### DETAILED DESCRIPTION

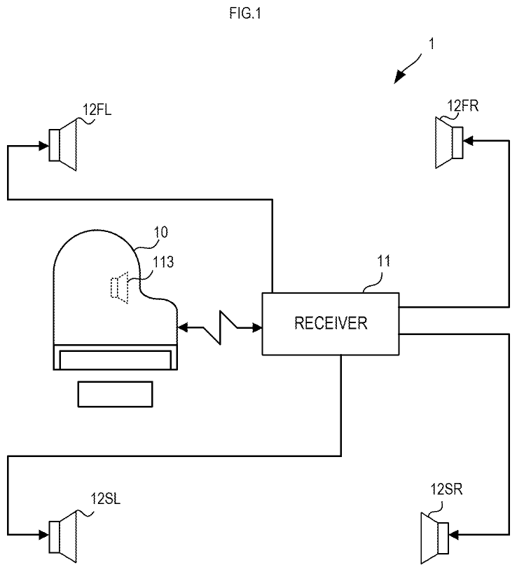

FIG. 1 is a diagram showing a configuration of a sound processing system 1. The sound processing system 1 has an electronic piano 10 and a receiver 11. The receiver 11 is connected to a plurality of speakers (speakers 12FL, 12FR, 12SL, 12SR). The speaker 12FL is disposed on the front left side of a user, the speaker 12FR is disposed on the front right side of the user, the speaker 12SL is disposed on the back left side of the user, and the speaker 12SR is disposed on the back right side of the user.

The electronic piano 10 is an example of an electronic musical instrument. Although the present embodiment shows the electronic piano 10 as an example of the electronic musical instrument, the electronic musical instrument includes another electronic keyboard instrument such as an electronic organ or a synthesizer. In addition, the electronic musical instrument of present disclosure is not limited to a keyboard instrument and includes all musical instruments that drive a sound source according to performance of a user and generate an audio signal.

The receiver 11 is an example of the sound processing apparatus of the present disclosure. The sound processing apparatus may be a personal computer, a set top box, a power amplifier, or a powered speaker, other than the receiver 11, for example. The sound processing apparatus of the present disclosure includes all apparatuses capable of performing effect processing on an audio signal.

The electronic piano 10 and the receiver 11 are connected through a network such as Bluetooth (registered trademark) or a wireless LAN. Alternatively, the electronic piano 10 and the receiver 11 may be connected by wire such as HDMI (registered trademark), MIDI, LAN, USB, or an audio cable.

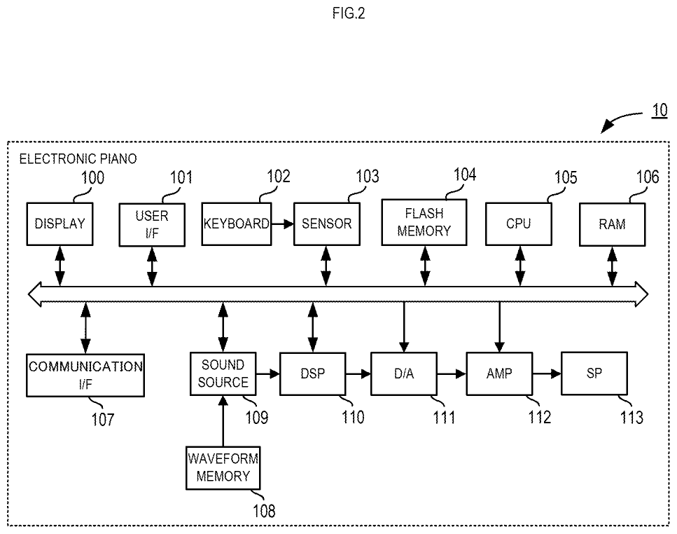

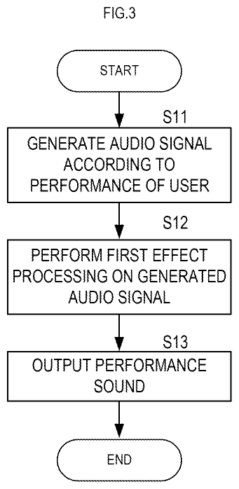

FIG. 2 is a block diagram showing a configuration of the electronic piano 10, and FIG. 3 is a flow chart showing an operation of the electronic piano 10.

The electronic piano 10 includes a display 100, a user interface (I/F) 101, a keyboard 102, a sensor 103, a flash memory 104, a CPU 105, a RAM 106, a communication interface (I/F) 107, a waveform memory 108, a sound source 109, a DSP 110, a D/A converter 111, an amplifier 112, and a speaker 113.

The display 100 includes an LED, an LCD (Liquid Crystal Display), or an OLED (Organic Light-Emitting Diode), for example, and mainly displays a state of the electronic piano 10.

The user I/F 101 includes a knob, a switch, a button, a touch panel, or the like, and receives an operation from a user.

The keyboard 102 receives a performance operation (a key press operation) of a user. The sensor 103 detects an operation of the keyboard 102.

The CPU 105 reads various programs stored in the flash memory 104 being a storage medium out to the RAM 106 and controls the electronic piano 10. For example, the CPU 105 generates performance information to drive the sound source 109 based on the operation of the keyboard 102 detected by the sensor 103. The performance information includes information to designate note-on, note-off, a velocity, or a tone.

The sound source 109 reads waveform data out from the waveform memory 108 based on the performance information generated by the CPU 105, and generates an audio signal. Accordingly, the sound source 109 generates an audio signal according to performance of a user (S11).

The DSP 110 is an example of a first signal processor of the present disclosure, and performs first effect processing on the audio signal generated by the sound source 109 to generate a first processed audio signal (S12). The first effect processing includes reverb processing to add a reverb component to the audio signal. The reverb processing is processing to simulate reverberation (a return sound) of a certain room by adding a predetermined delay time to a received audio signal, and generating a level-adjusted pseudo reflected sound.

The DSP 110 outputs the audio signal on which the first effect processing has been performed, to the D/A converter 111.

The D/A converter 111 converts a digital audio signal received from the DSP 110 into an analog audio signal. The amplifier 112 amplifies the analog audio signal.

The speaker 113 corresponds to a first sound emitter of the present disclosure, and outputs a performance sound based on the analog audio signal amplified by the amplifier 112 (S13). In short, the speaker 113 emits a first performance sound component including the audio signal (an audio signal of a direct sound) generated by the sound source 109.

In such a manner, the electronic piano 10 outputs the performance sound in accordance with the performance of a user.

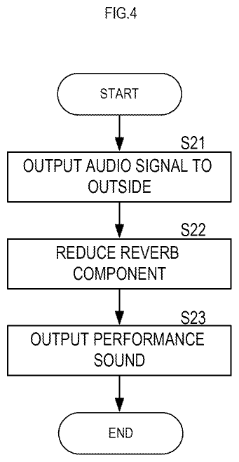

Then, the electronic piano 10, in a case of detecting a connection to the receiver 11, performs the following operations. FIG. 4 is a flow chart showing the operations of the electronic piano 10 when the connection to the receiver 11 is detected.

The CPU 105, in the case of detecting the connection to the receiver 11, outputs the audio signal generated by the sound source 109 to an outside through the communication I/F 107 (S21). The communication I/F 107 is an example of a first audio signal output of the present disclosure, and outputs the audio signal generated by the sound source 109 to the outside.

The DSP 110 changes the amount of the first effect processing to the generated audio signal in generating the first processed audio signal that is emitted by the speaker 113 from the state where the audio signal is not output to the outside. More specifically, the DSP 110, when outputting the audio signal from the communication I/F 107 to the outside, reduces a reverb component (S22). For example, the DSP 110 may reduce the level of the reverb component or may reduce the reverb component by reducing reverb duration time. Alternatively, the DSP 110, by turning off the reverb processing, may reduce the reverb component. Turning off the reverb processing will set the amount of the first effect processing to 0.

The DSP 110 outputs the audio signal of which the reverb component is reduced, to the speaker 113 through the D/A converter 111 and the amplifier 112. The speaker 113 outputs a performance sound based on the first processed audio signal (S23). In short, the speaker 113 emits the first performance sound component of which the reverb component is reduced. When the DSP 110 turns OFF the reverb processing, the speaker 113 only emits the first performance sound component of the audio signal (the audio signal of a direct sound) generated by the sound source 109.

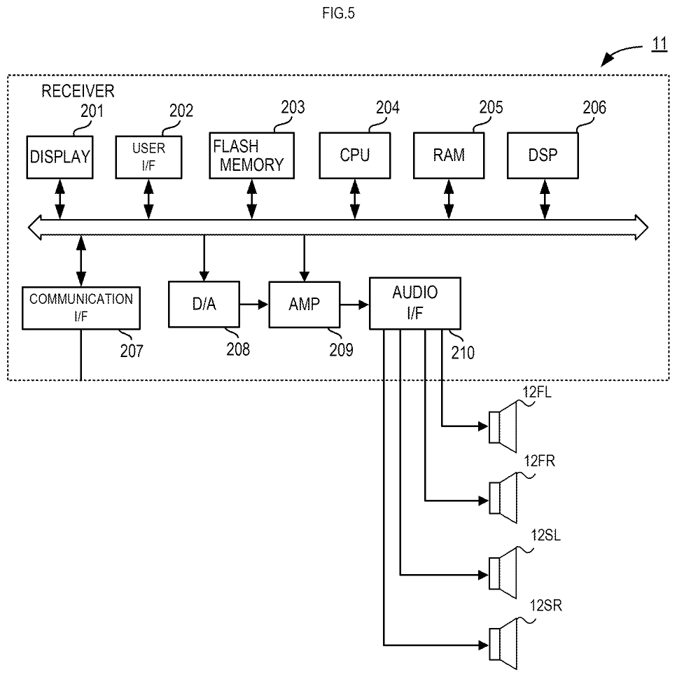

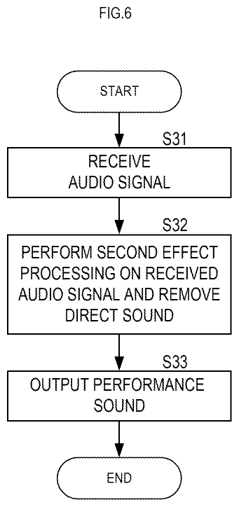

FIG. 5 is a block diagram showing a configuration of the receiver 11, and FIG. 6 is a flow chart showing an operation of the receiver 11.

The receiver 11 includes a display 201, a user I/F 202, a flash memory 203, a CPU 204, a RAM 205, a DSP 206, a communication I/F 207, a D/A converter 208, an amplifier 209, and an audio interface (I/F) 210.

The display 201 includes an LED, an LCD, or an OLED, for example, and displays various information.

The user I/F 202 includes a knob, a switch, a button, a touch panel, or the like, and receives an operation from a user.

The CPU 204 is a controller that controls an operation of the receiver 11. The CPU 204 reads and executes a program stored in the flash memory 203 being a storage medium out to the RAM 205 and performs various types of operations.

The communication I/F 207 corresponds to a first audio signal receiver of the present disclosure, and receives an audio signal from the electronic piano 10 (S31).

The DSP 206 is an example of a second signal processor of the present disclosure, and performs second effect processing on the audio signal received by the communication I/F 207 (S32). The second effect processing includes reverb processing to add a reverb component. The second effect processing includes removing the direct sound component from the received audio signal, to generate the second processed audio signal.

More specifically, the reverb processing in the second effect processing is processing to reproduce reverberation of a predetermined acoustic space such as a specific concert hall, a club with live music, or a church. The reverb processing in the second effect processing is processing to convolve an impulse response previously obtained by a microphone placed in a certain position (such as an audience seat or a stage) in an actual concert hall, a club with live music, a church, or the like, to an audio signal.

The reverb processing in the second effect processing is able to reproduce a reflected sound longer than the reverb processing in the first effect processing, and is able to reproduce reverberation more similar to reverberation of an actual hall.

In addition, the reverb processing in the second effect processing includes processing to add localization to each reflected sound corresponding to an impulse response by distributing an audio signal according to a reverb component to the plurality of speakers (the speakers 12FL, 12FR, 12SL, 12SR). For example, when the speaker 12FL and the speaker 12SL receive an input of the audio signal of a reflected sound at the same volume and at the same timing, a user perceives the reflected sound at a position between the speaker 12FL and the speaker 12SL, that is, on the left side of the user.

The receiver 11 distributes an audio signal to the plurality of speakers (the speakers 12FL, 12FR, 12SL, 12SR), based on positions of the plurality of speakers (the speakers 12FL, 12FR, 12SL, 12SR), so that the reflected sound is localized at the same position as the position of an actual hall or the like. The positions of the plurality of speakers (the speakers 12FL, 12FR, 12SL, 12SR) are able to be detected, for example, by outputting a test sound from the plurality of speakers (the speakers 12FL, 12FR, 12SL, 12SR) and collecting the test sound by the microphone placed in the position of the user. In addition, the position of the reflected sound in the real hall is obtainable by placing a plurality of microphones in the actual hall and measuring an impulse response.

As a result, the user can perceive that the reflected sound may arrive from a position similar to an acoustic space such as a hall desired by the user.

The flash memory 203 obtains previously and stores an impulse response of a plurality of acoustic spaces. The user can select a desired acoustic space from the plurality of acoustic spaces (a specific concert hall, a club with live music, a church, or the like), through the user I/F 202. Alternatively, the user may select a desired acoustic space through the user I/F 101 of the electronic piano 10. In such a case, the electronic piano 10 obtains information indicating names of the plurality of acoustic spaces from the receiver 11, and displays the names on the display 100. The user selects a desired acoustic space from a plurality of displayed acoustic spaces. The electronic piano 10 sends the information indicating the name of a selected acoustic space to the receiver 11.

In addition, the flash memory 203 may obtain previously and store a plurality of impulse responses in a listening environment different mainly depending on whether seats are empty or full, even in the same acoustic space. In such a case, the user may select the name of the acoustic space, and the listening environment.

The DSP 206 reads an impulse response of a selected acoustic space out from the flash memory 203, and convolves the impulse response to an audio signal received by the communication I/F 207. The DSP 206 outputs the audio signal on which the second effect processing has been performed, to the D/A converter 208.

The D/A converter 208 converts a digital audio signal received from the DSP 206 into an analog audio signal. The amplifier 209 amplifies the analog audio signal.

The audio I/F 210 includes a speaker connection terminal and outputs the audio signal amplified by the amplifier 209 to the plurality of speakers (the speakers 12FL, 12FR, 12SL, 12SR). The audio I/F 210 and the plurality of speakers correspond to a second sound emitter of the present disclosure. The speakers 12FL, 12FR, 12SL, and 12SR output a performance sound based on audio signals supplied from the audio I/F 210, respectively (S33). In short, the audio I/F 210 and the plurality of speakers emits a second performance sound component based on the second processed audio signal.

The first performance sound component is a sound of which a reverb component is reduced, and the second performance sound component is a sound to which the reverb component is added by the receiver 11 and from which the direct sound component is removed.

As a result, the sound processing system 1 is able to provide a rich effect sound that is unrealizable in the first effect processing of an electronic musical instrument, to a user. More specifically, the receiver 11 performs the reverb processing by using the impulse response previously obtained in the acoustic space such as an actual hall. The receiver 11 also reproduces the sense of localization of a reflected sound by using the plurality of speakers (the speakers 12FL, 12FR, 12SL, 12SR). Therefore, the receiver 11 is able to reproduce a reflected sound similar to the reverberation of the actual acoustic space, by the first effect processing of the electronic piano 10.

As a result, the user can perceive as if being performing in an acoustic space such as a real hall. In addition, the user can select a favorite virtual acoustic space from virtual acoustic spaces such as a specific concert hall, a club with live music, or a church, through the user I/F 202. As a result, the sound processing system 1, in the performance by use of an electronic musical instrument, is able to cause a user to experience as if the favorite virtual acoustic space of the user is present in a real space and the user is performing in the favorite virtual acoustic space of the user.

In addition, the second performance sound component to be emitted by the plurality of speakers (the speakers 12FL, 12FR, 12SL, 12SR) is a sound from which the direct sound component is removed. The direct sound component is outputted only from the speaker 113 of the electronic piano 10. Therefore, a sound of the direct sound component is not emitted in a position different from the electronic piano 10, which does not give a feeling of strangeness to the performance.

### (First Modification)

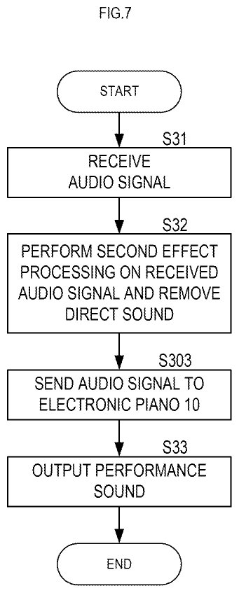

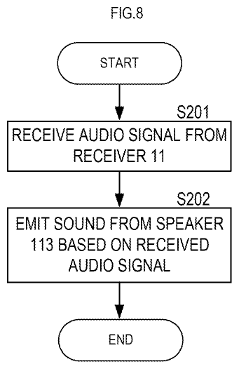

FIG. 7 is a flow chart showing the operation of the receiver 11, and FIG. 8 is a flow chart showing the operation of the electronic piano 9.

The receiver 11 of the sound processing system 1 according to the first modification emits the second performance sound component also from the speaker 113 of the electronic piano 10, as the plurality of speakers in addition to the speaker 12FL, 12FR, 12SL, and 12SR that are connected to the own apparatus.

As shown in FIG. 7, the receiver 11 sends the audio signal on which the second effect processing has been performed, to the electronic piano 10 through the communication I/F 207 (S303). In such a case, the communication I/F 207 corresponds to a second audio signal output of the present disclosure.

The receiver 11 is able to detect the position of the speaker 113 by outputting a test sound from the speaker 113 and collecting the test sound by the microphone placed in the position of a user. The receiver 11 distributes an audio signal to these speakers, based on each position of the speaker 113 and the speakers 12FL, 12FR, 12SL, and 12SR, so that a reflected sound is localized at the same position as the position of the actual hall or the like. The audio signal to be distributed to the speaker 113 is sent to the electronic piano 10 through the communication I/F 207, as described above.

As shown in FIG. 8, the electronic piano 10 receives an audio signal from the receiver 11 through the communication I/F 107 (S201). In such a case, the communication I/F 107 corresponds to a second audio signal receiver of the present disclosure. The electronic piano 10 emits the second performance sound component from the speaker 113 based on a received audio signal (S202).

Accordingly, the sound processing system 1 according to the first modification further emits the second performance sound component by using the speaker 113 of the electronic piano 10. As a result, the sound processing system 1 is able to reproduce a richer reverberation.

### (Second Modification)

The above embodiment shows an example in which the electronic piano 10, in a case of detecting a connection to the receiver 11, sends an audio signal to the receiver 11 and emits the second performance sound component by the receiver 11. In contrast, the electronic piano 10 of the second modification, in a case of receiving an operation from a user by the user I/F 101, may send an audio signal to the receiver 11, and may emit the second performance sound component by the receiver 11. For example, the user I/F 101 has a switch displayed as “External Reverb.” When a user turns ON the switch of “External Reverb,” the electronic piano 10 sends an audio signal to the receiver 11, and emits the second performance sound component by the receiver 11.

In addition, the user I/F 101 may have a physical controller such as a knob displayed as “Reverb Level.” For example, the user can set 5 stages of “Reverb Levels.” When the user sets “Reverb Level” to any of 1 to 4 stages, the electronic piano 10 performs the reverb processing of the first effect processing, and does not send an audio signal to the receiver 11. On the other hand, when the user sets “Reverb Level” to the maximum 5 stage, the electronic piano 10 sends an audio signal to the receiver 11, and emits the second performance sound component by the receiver 11.

### (Third Modification)

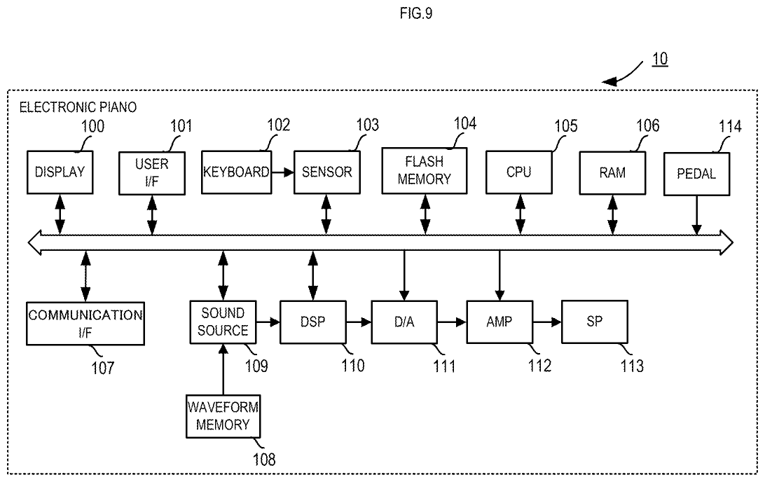

FIG. 9 is a block diagram showing a configuration of an electronic piano 10 according to a third modification. The electronic piano 10 according to the third modification further includes a pedal 114.

The pedal 114 is an example of the physical controller of the present disclosure, and is an example of the physical controller for changing a parameter of the second effect processing. The electronic piano 10 detects an amount of pressing of the pedal 114, and sends information indicating the amount of pressing to the receiver 11. The receiver 11 receives the information indicating the amount of pressing and changes the parameter of the second effect processing according to received information indicating the amount of pressing.

For example, the receiver 11 adds a reverb component of which a reverberation time is increased as the amount of pressing is increased. As a result, the user can change the parameter of the second effect processing according to the amount of pressing of the pedal. In short, the user does a performance, and can adjust the strength of reverberation while listening to a performance sound.

It is to be noted that the electronic piano 10, in a case in which the amount of pressing is less than or equal to a predetermined value, may perform the reverb processing of the first effect processing and may send no audio signal to the receiver 11, and, in a case in which the amount of pressing exceeds the predetermined value, may send an audio signal to the receiver 11 and may emit the second performance sound component by the receiver 11.

### (Fourth Modification)

An electronic piano 10 or a receiver 11 of a fourth modification receives a designation in a stage mode and an audience seat mode. The stage mode is a mode in which reverb processing is performed by use of an impulse response previously obtained by a microphone placed on a stage in an acoustic space such as an actual hall. The audience seat mode is a mode in which reverb processing is performed by use of an impulse response previously obtained by a microphone placed on an audience seat in an acoustic space such as an actual hall.

The flash memory 203 obtains previously and stores both of an impulse response obtained on the stage and an impulse response obtained on the audience seat, even in the same acoustic space.

A user designates the stage mode or the audience seat mode, through the user I/F 101 of the electronic piano 10 or the user I/F 202 of the receiver 11. The receiver 11, in a case of receiving the stage mode, reads the impulse response obtained by the microphone on a stage out from the flash memory 203, and performs the second effect processing. The receiver 11, in a case of receiving the audience seat mode, reads the impulse response obtained by the microphone on an audience seat out from the flash memory 203, and performs the second effect processing.

As a result, the user can also perceive as if being performing on a stage of a real hall, and can also perceive as if listening to playing in an audience seat.

It is to be noted that the stage mode may further include a first stage mode in which the audience seat is on the right side viewed from the electronic piano 10 and a second stage mode in which the audience seat is on the left side viewed from the electronic piano 10. The receiver 11 inverts the left and right of an audio signal to be distributed to the plurality of speakers, in the first stage mode and the second stage mode.

As a result, the user can also perceive as if being performing on the stage of a real hall with audience seats on the right side, and can also perceive as if being performing with the audience seats on the left side.

### (Fifth Modification)

In the above embodiment, the second performance sound component is a sound to which the reverb component is added by the receiver 11 and from which the direct sound component is removed. However, the receiver 11 does not need to remove all direct sound components from the received audio signal. The second performance sound component may slightly include the direct sound component. In other words, the second performance sound component to be emitted by the receiver 11 may include the reverb component as a main component.

### (Sixth Modification)

In the above embodiment, the electronic piano 10, in a case of outputting an audio signal to the outside, performs processing to reduce a reverb component. However, the electronic piano 10, in the case of outputting an audio signal to the outside, does not necessarily need to reduce the reverb component. The electronic piano 10, in a case of outputting no audio signal to the outside and performing no reverb processing, maintains a state in which the reverb processing is not performed even in the case of outputting an audio signal to the outside. Alternatively, in a case in which a reflected sound of the reverb processing performed by the electronic piano 10 is short or in a case in which the level of the reflected sound is low, the electronic piano 10 does not need to reduce the reverb component. The first performance sound component may slightly include the reverb component. In other words, the first performance sound component may include the direct sound as the main component.

The description of the present embodiments is illustrative in all points and should not be construed to limit the present disclosure. The scope of the present disclosure is defined not by the foregoing embodiments but by the following claims. Further, the scope of the present disclosure is intended to include all modifications within the scopes of the claims and within the meanings and scopes of equivalents.

For example, although the above embodiments show the reverb processing as an example of the effect processing, the effect processing may be other effect processing such as equalizer or chorus.

What is claimed is:

1. A sound processing system comprising:
an electronic musical instrument comprising:
an audio signal generator that generates an audio signal according to a user performance on the electronic musical instrument;
a first signal processor that performs first effect processing on the audio signal to generate a first processed audio signal;
a first sound emitter that emits a first performance sound component based on at least one of the first processed audio signal or a second processed audio signal; and
a first audio signal output that outputs the audio signal; and
a sound processing apparatus, which is communicable with the electronic musical instrument, comprising:
a first audio signal receiver that receives the audio signal output from the first audio signal output, in a state where the electronic musical instrument is communicating with the sound processing apparatus;
a second signal processor that performs second effect processing on the received audio signal, including removing a direct sound component from the received audio signal, to generate the second processed audio signal; and
a second sound emitter that emits a second performance sound component based on the second processed audio signal,
wherein in the state where the electronic musical instrument is communicating with the sound processing apparatus:
the first signal processor changes the amount of the first effect processing to the generated audio signal in generating the first processed audio signal that is emitted by the first sound emitter, in a state where the audio signal is not output to the sound processing apparatus; or
the first sound emitter emits the second performance sound component based on the second processed audio signal.

2. The sound processing system according to claim 1, wherein the first effect processing and the second effect processing each include adding a reverb component.

3. The sound processing system according to claim 2, wherein the change in the amount of the first effect processing includes reducing the reverb component.

4. The sound processing system according to claim 1, wherein:
the sound processing apparatus further comprises a second audio signal output that outputs the second processed audio signal;
the electronic musical instrument further comprises a second audio signal receiver that receives the second processed audio signal, in the state where the electronic musical instrument is communicating with the sound processing apparatus; and
the first performance sound component emitted by the first sound emitter is based on the second processed audio signal.

5. The sound processing system according to claim 1, wherein the electronic musical instrument and the sound processing apparatus are communicable through a network.

6. The sound processing system according to claim 1, wherein the second sound emitter includes a plurality of speakers that emit the second performance sound component.

7. The sound processing system according to claim 1, wherein the electronic musical instrument is a keyboard instrument.

8. The sound processing system according to claim 1, wherein the first signal processor detects communication with the sound processing apparatus and changes the amount of the first effect processing upon detecting the communication.

9. The sound processing system according to claim 1, wherein the electronic musical instrument further comprises a physical controller that changes a parameter of the second effect processing of the sound processing apparatus.

10. A sound processing method for a sound processing system comprising an electronic musical instrument, including a first sound emitter, and a sound processing apparatus, including a second sound emitter, communicable with the electronic musical instrument, the method comprising:
with the electronic musical instrument:
generating an audio signal according to a user performance on the electronic musical instrument;
performing first effect processing on the audio signal to generate a first processed audio signal;
emitting, via the first sound emitter, a first performance sound component based on at least one of the first processed audio signal or a second processed audio signal; and
outputting the audio signal;
with the sound processing apparatus:
receiving the audio signal output from the electronic musical instrument, in a state where the electronic musical instrument is communicating with the sound processing apparatus;
performing second effect processing on the received audio signal, including removing a direct sound component from the received audio signal, to generate a second processed audio signal; and
emitting, via the second sound emitter, a second performance sound component based on the second processed audio signal,
wherein in the state where the electronic musical instrument is communicating with the sound processing apparatus:
the sound processing apparatus changes the amount of the first effect processing to the audio signal in generating the first processed audio signal that is emitted by the first sound emitter, in a state where the audio signal is not output to the sound processing apparatus; or
the first sound emitter emits the second performance sound component based on the second processed audio signal.

11. The sound processing method according to claim 10, wherein the first effect processing and the second effect processing each include adding a reverb component.

12. The sound processing method according to claim 11, wherein the change in the amount of the first effect processing includes reducing the reverb component.

13. The sound processing method according to claim 10, the method further comprising:
the sound processing apparatus outputting the second processed audio signal;
the electronic musical instrument receiving the second processed audio signal, in the state where the electronic musical instrument is communicating with the sound processing apparatus; and
the first performance sound component emitted by the first sound emitter is based on the second processed audio signal.

14. The sound processing method according to claim 10, wherein the electronic musical instrument and the sound processing apparatus are communicable through a network.

15. The sound processing method according to claim 10, wherein the second sound emitter includes a plurality of speakers that emit the second performance sound component.

16. The sound processing method according to claim 10, wherein the electronic musical instrument is a keyboard instrument.

17. The sound processing method according to claim 10, the method further comprising the electrical musical instrument detecting communication with the sound processing apparatus and changes the amount of the first effect processing upon detecting the communication.

18. The sound processing method according to claim 10, wherein:
the electronic musical instrument further comprises a physical controller, and
the method further comprises the electronic musical instrument changing a parameter of the second effect processing of the sound processing apparatus via the physical controller.
